(19) United States
(12) Patent Application Publication
(10) Pub. No.: US 2014/0048021 A1
(43) Pub. Date: Feb. 20, 2014

(54) SYSTEMS AND METHODS FOR RETROFITTING LIQUID VAPORIZERS WITH LANCES OF DIFFERENT SHAPES

(71) Applicants: Vaughn R. Watson, Frisco, TX (US); Russell T. Bryan, Arlington, TX (US)

(72) Inventors: Vaughn R. Watson, Frisco, TX (US); Russell T. Bryan, Arlington, TX (US)

(73) Assignee: Peerless Mfg. Co., Dallas, TX (US)

(21) Appl. No.: 13/585,272

(22) Filed: Aug. 14, 2012

(51) Int. Cl. F22B 37/10; B23P 11/00

(52) U.S. Cl. 122/511; 29/890.07

(57) ABSTRACT

Methods for retrofitting vaporizers to have lances of a different cross sectional shape than lances previously installed in the vaporizers without having to carry out extensive modifications to manifolds that are attached to the lances or without using coupling tubes that transition from a first cross sectional shape to a second cross sectional shape. Plated lances for retrofitting a vaporizer. The plated lances include lances connected to a plate having an orifice configured so that fluid flows through the orifice into a lumen of the lance.

### CROSS-REFERENCE TO RELATED APPLICATIONS

The present application is related to commonly assigned U.S. patent application Ser. No. 29/429,283 entitled “Injection Lance Plate” filed on Aug. 8, 2012.

### TECHNICAL FIELD

The current disclosure generally relates to liquid vaporizers and specifically to systems and methods for retrofitting liquid vaporizers with lances of different shapes.

### BACKGROUND

A vaporizer is equipment for transforming an element or compound from liquid phase to vapor phase (gas). Transforming a liquid to gas usually involves the application of heat to the liquid. For example, the production of steam from water by heating the water to its boiling point is a well known vaporization process. In industrial plants, such as power plants, chemical plants, petrochemical plants, petroleum refineries, natural gas processing plants and the like, there may be aspects of the plants' process that vaporize liquid. Examples of vaporization processes at industrial plants include the production of steam from water, the vaporization of liquid ammonia, the vaporization of liquefied natural gas, and the like.

Because vapor usually rises when formed, vaporizer vessels are typically constructed as hollow cylindrical columns. Generally, heat is applied at the bottom of the column, while the liquid to be vaporized is injected above the source of heat. Once sufficient heat is applied to the liquid to raise it to at least its boiling point, the transformation from liquid to vapor takes place. The vapor rises and is withdrawn from the top of the column. The heat may be supplied by various types of heating media and is usually delivered through an inlet pipe. The liquid being vaporized may be introduced into the vaporizer through rings or through lances as described in patent application Ser. No. 12/958,257 entitled “System and Methods for Liquid Vaporizers and Operations Thereof”. As improvements are made to components of vaporizers, systems and methods are needed to retrofit existing vaporizers with the improved components.

### BRIEF SUMMARY

Recently, improvements have been made to the configuration of lances. Specifically, lances are not only produced in the typical cylindrical shape but are now also produced to have other shapes such as a quadrilateral cross sectional shape. The current disclosure is directed to systems and methods for retrofitting vaporizers to have lances of a different cross sectional shape than lances previously installed in the vaporizers without having to carry out extensive modifications to manifolds that are attached to the lances or without using coupling tubes that transition from an original cross sectional shape to a new cross sectional shape.

Embodiments of the disclosure include a method of retrofitting a vaporizer having a vessel with one or more lances disposed within the vessel. The method includes replacing, in the vaporizer, a first lance having a first cross sectional shape with a second lance having a second cross sectional shape. A retrofitting plate is connected to a first end of the second lance. The retrofitting plate also includes an orifice configured so that fluid flows through the orifice into a lumen of the second lance.

Embodiments of the disclosure include a method of retrofitting a vaporizer having a vessel with a lance cluster attached to a main manifold external to the vessel by a tubular transition connector. The method includes removing the lance cluster from the vessel and removing the tubular transition connector from the main manifold. The method further includes inserting one or more plated lances into the vessel. Each of the plated lances includes a lance and a plate connected to a first end of the lance. The plate may be configured as described above. The method also includes connecting the plate end of the plated lances to one or more manifolds extending from the main manifold.

Further, embodiments of the disclosure include a retrofitting plate for connecting a manifold to a lance having a quadrilateral cross sectional shape. The lance is configured to be used in a vessel of a vaporizer. The plate includes an orifice configured so that fluid flows through the orifice into a lumen of the lance. The plate also includes a recess around the orifice and the recess is adapted to receive the lance having the quadrilateral cross sectional shape such that a perimeter of the recess has the same shape as the lance's cross sectional shape.

Further yet, embodiments of the disclosure include a plated lance for retrofitting a vaporizer. The plated lance includes a lance having a quadrilateral cross sectional shape and a plate connected to a first end of the lance. The plate also includes an orifice configured so that fluid flows through the orifice into a lumen of the lance.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following descriptions taken in conjunction with the accompanying drawing, in which:

FIG. 1 shows a method of retrofitting a vaporizer according to embodiments of the disclosure;

FIGS. 2A to 2F show steps for retrofitting vaporizer systems according to embodiments of the disclosure;

FIGS. 3A-3C show retrofitting plates according to embodiments of the disclosure;

FIGS. 4A and 4B show prior art vaporizer systems;

FIG. 5 shows a vaporizer system with cylindrical lances;

FIG. 6 shows a vaporizer system for cylindrical lances; and

FIG. 7 shows a prior art vaporizer system.

### DETAILED DESCRIPTION OF THE DISCLOSURE

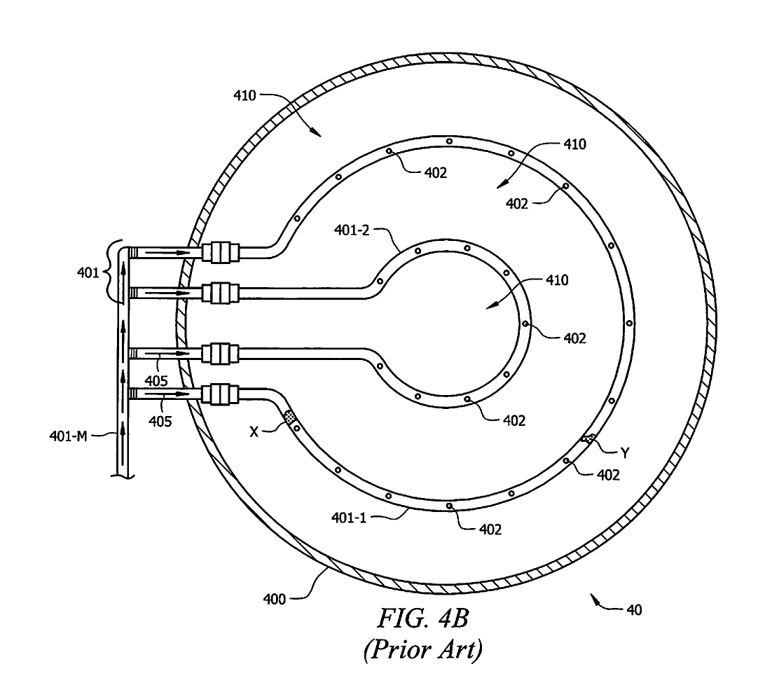

FIGS. 4A, 4B, and 5-7 show different designs of vaporizers used in industrial plants. FIG. 4A shows a typical vaporizer, vaporizer 40, that utilizes injection rings. As described in patent application Ser. No. 12/958,257 entitled “System and Methods for Liquid Vaporizers and Operations Thereof”, the disclosure of which is incorporated by reference, vaporizer 40 of FIG. 4A may be used for vaporizing liquids. For instance, vaporizer 40 may be used in industrial plants to produce steam from water, vaporize ammonia, vaporize liquefied natural gas, and the like. With respect to ammonia, for example, power plants use ammonia vapor in a process known as selective catalytic reduction (SCR). SCR seeks to reduce the amount of nitrogen oxides emitted as a result of burning fossil fuels. Vaporizer 40 includes vessel 400, which has liquid injection rings 401 disposed within it. Liquid 405 (which may be liquid ammonia or any other liquid that needs to be vaporized) flows from a storage vessel (not shown), through valve 409, through liquid injection rings 401, and into vessel 400. Liquid injection rings 401 include holes 402 through which liquid 405 is injected into open space 410 within vessel 400. From open space 410, liquid 405 falls onto poly-rings 412. Poly-rings 412 are typically made of metal and provide a large contact surface area for liquid 405. Poly-rings are supported in vessel 400 by sieve plate 413.

Concurrent with the injection of liquid 405 into vessel 400, blower 404 blows heating medium 406 into vessel 400 through inlet pipe 403. Heating medium 406 may be various different types of heated gas such as air, steam, flue gas, the like and combinations thereof. As heating medium 406 rises, it passes through sieve plate 413, contacts and heats poly-rings 412 and liquid 405. Heating medium 406 will have a higher temperature than liquid 405 and poly-rings 412. Consequently, heat is transferred from heating medium 406 to liquid 405 directly and to poly-rings 212, which in turn supplies heat to liquid 405. As liquid 405 absorbs heat it vaporizes to form vapor 407 when the temperature reaches at least the boiling point of liquid 405. As vapor 407 is formed it rises and exits vessel 400 through outlet pipe 408.

Turning to FIG. 4B, shown is a cross sectional plan view of prior art vessel 400 that illustrates the configuration of liquid injection rings 401. Liquid injection rings 401 are circular in shape and concentric with the shape of vessel 400. Liquid 405 is introduced into vessel 400, typically as small droplets. Holes 402 form the mist of liquid droplets as liquid 405 flows through holes 402. As can be seen by the placement of holes 402, liquid 405 is dispersed by liquid injection rings 401 throughout open space 410.

Liquid injection rings 401 are typically made from metal and, depending on the properties of liquid 405, they may periodically require maintenance such as repairing ruptures, clearing blockages and the like. FIG. 4B shows liquid injection rings 401 including liquid injection ring 401-1 and liquid injection ring 401-2. Manifold 401-M feeds liquid to liquid injection rings 401.

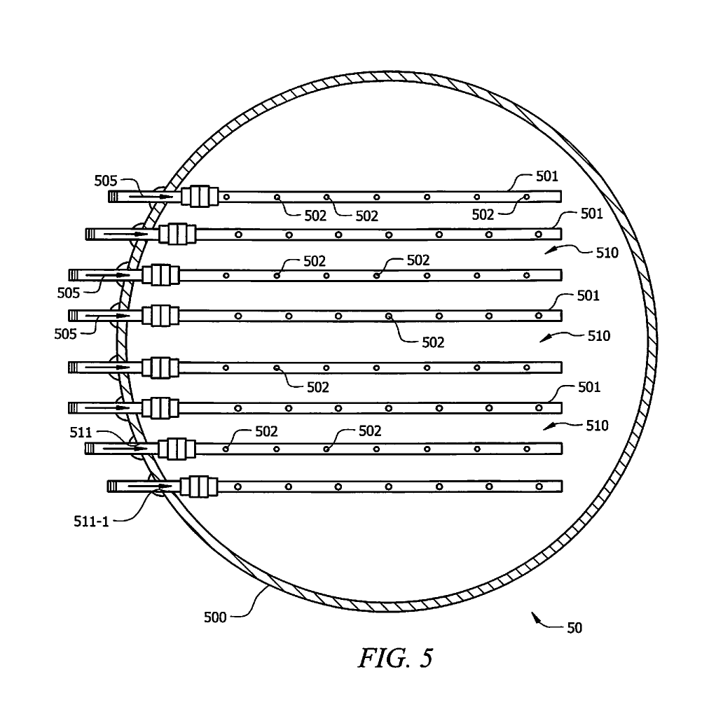

FIG. 5 shows a cross-sectional plan view of a vaporizer 50, which utilizes cylindrical lances. In this embodiment, lances 501 are straight hollow tubes that enter through the walls of vessel 500 via orifices 511. Liquid 105 flows to vaporizer 50 through lances 501 and is injected into vessel 500's open space 510 via holes 502 in lances 501. Lances 501 extend from the inside to the outside of vessel 500 when installed in vaporizer 50. Similar to the process described above with respect to vaporizer 50, a blower blows a heating medium into vessel 500 through inlet pipe 503, concurrent with the introduction of liquid 105 into vessel 500, as shown in FIG. 4A. As the heating medium rises, it contacts liquid 105 in open space 510 and transforms liquid 105 from liquid phase into vapor phase.

In FIG. 5, one or more of lances 501 may need repair. If lance 501-1 needs repair, lance 501-1 is simply pulled out of vessel 500 through orifice 511-1 without disrupting the operation of vaporizer 50. Once lance 501-1 is removed, orifice 511-1 may be closed in various manners or even left open, depending on the type of operation of vaporizer 50. As such, vaporizer 50 may continue in service while lance 501-1 is being repaired outside of vaporizer 50. When lance 501-1 is repaired, it may be returned to operation by re-insertion through orifice 511-1.

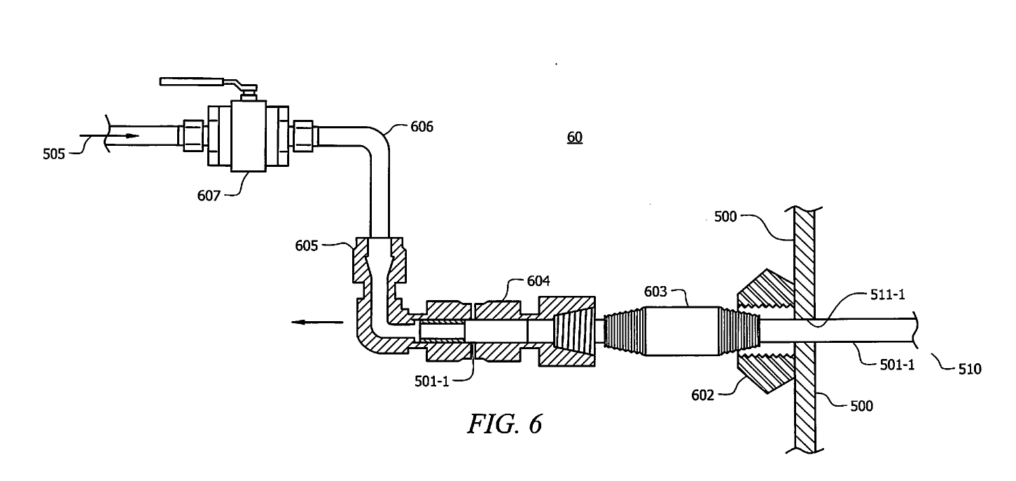

FIG. 6 show equipment that couple the cylindrical lances to the vaporizer. Equipment 60 may be used to deliver liquid 505 to vessel 500 and to facilitate the removal of lance 501-1 from vessel 500. Lance 501-1 extends from elbow 605 through device 604, pipe 603, device 602 and orifice 511-1 into open space 510 of vaporizer 50. Device 602 is attached to the wall of vessel 500. Device 602 is configured to receive and couple to one end of pipe 603. Device 602 and pipe 603 may be coupled together by a screw and thread mechanism but other coupling methods may also be used. The other end of pipe 603 is coupled to device 604 (e.g., by screw and thread). In turn, device 604 is coupled to elbow 605 by a detachable coupling (not shown). Elbow 605 is connected to valve 607 by elbow pipe 606 and valve 607 regulates the flow of liquid 505 from its source to elbow 606 and eventually into vessel 500.

As noted above, a screw thread mechanism may be used to connect components of the vaporizer. Currently, however, screw thread mechanisms are disfavored in some applications (e.g. processes that involve mixing of ammonia) because the screw thread mechanism is prone to leaking.

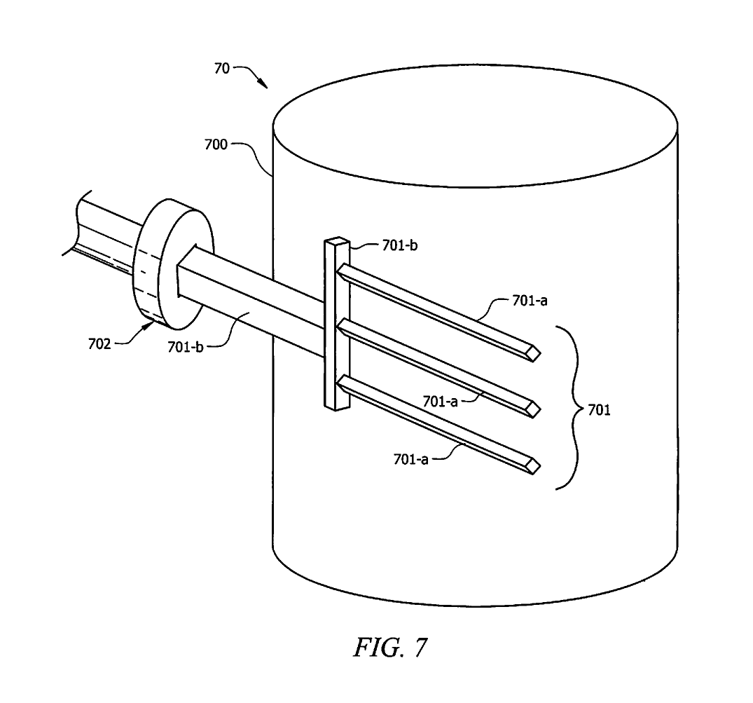

FIG. 7 shows a prior art vaporizer system 70. Vaporizer system 70 includes lance cluster 701 for injecting fluid into vessel 700. Lances 701-a are in fluid communication with header 701-b. Lances 701-a and header 701-b form a unitary structure manufactured for installation within vessel 700. As discussed in U.S. Pat. No. 7,383,850, entitled “Reagent Injection Grid,” the disclosure of which is incorporated by reference herein, the design of lances as shown in FIG. 7 improves mixing of a fluid that flows through lances 701-a with fluids in vessel 700. In operation, however, vaporizer system 70 poses some challenges. For example, the piping to which lance cluster 701 is attached is usually circular. This necessitates a coupling section that transitions from a quadrilateral cross sectional shape to a circular cross sectional shape by using blind flanges that have square holes bored in them. Lance cluster 701, however, is difficult to maintain. Specifically, it is difficult to clean the internal portions of lances 701-a. That is, because header 701-b effectively seals off one end of lances 701-a (and the other end is also sealed), it is difficult to remove material located in the lumen of lance 701-a.

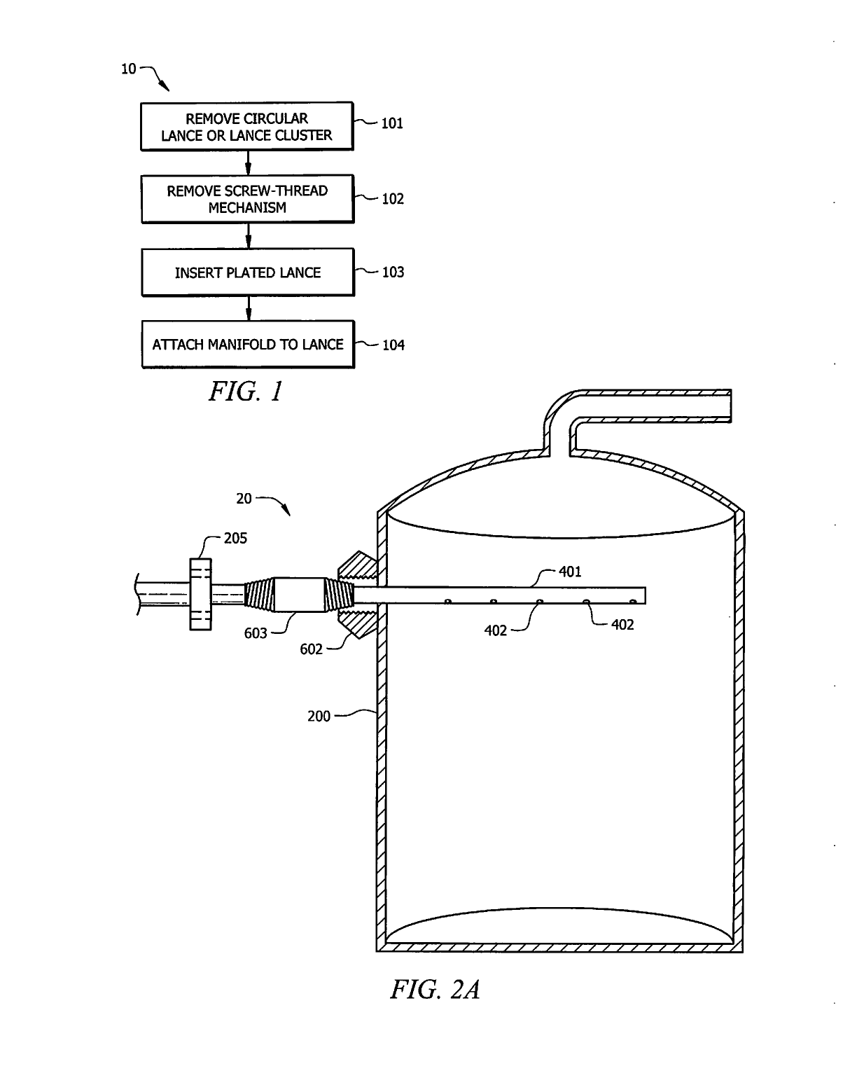

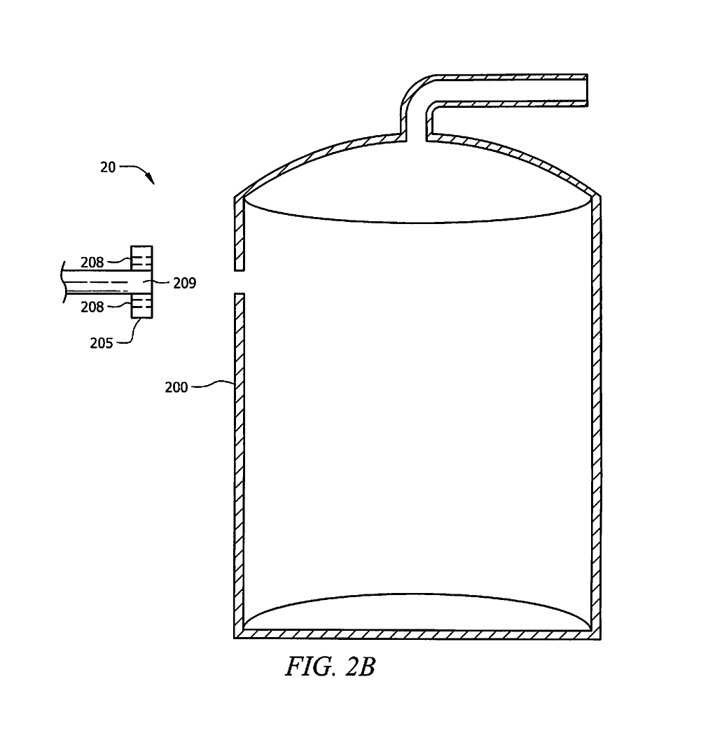

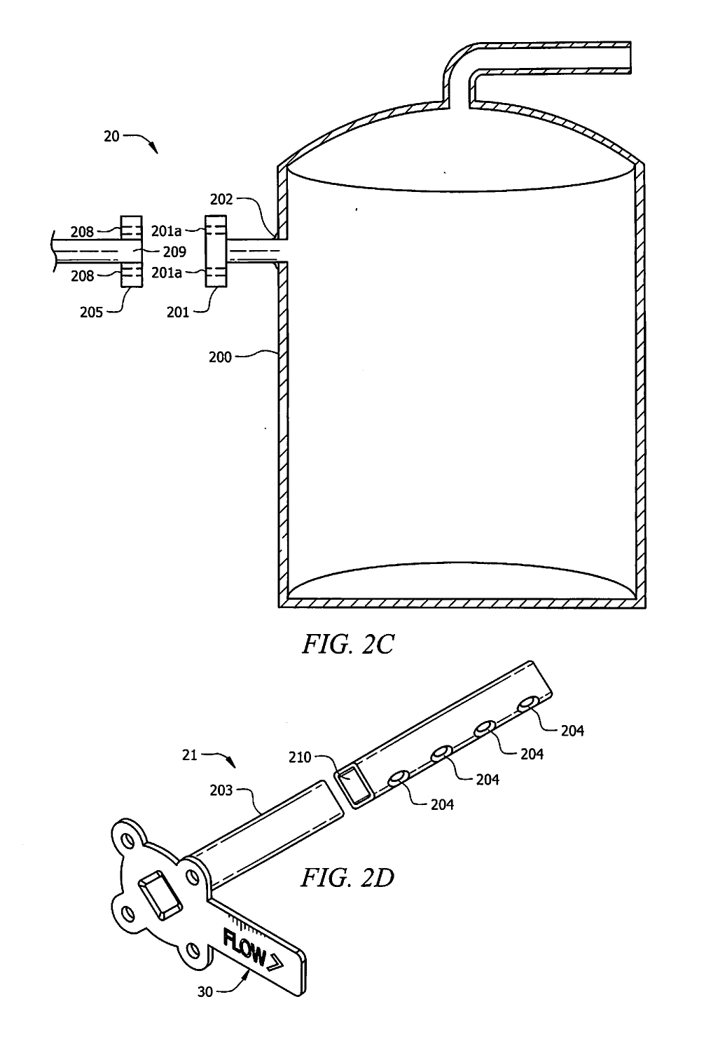

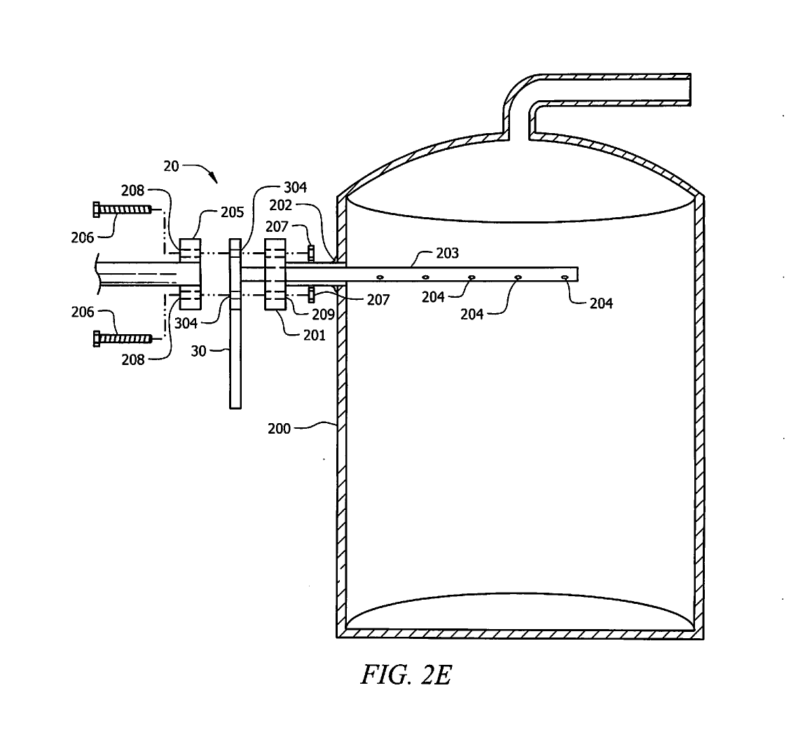

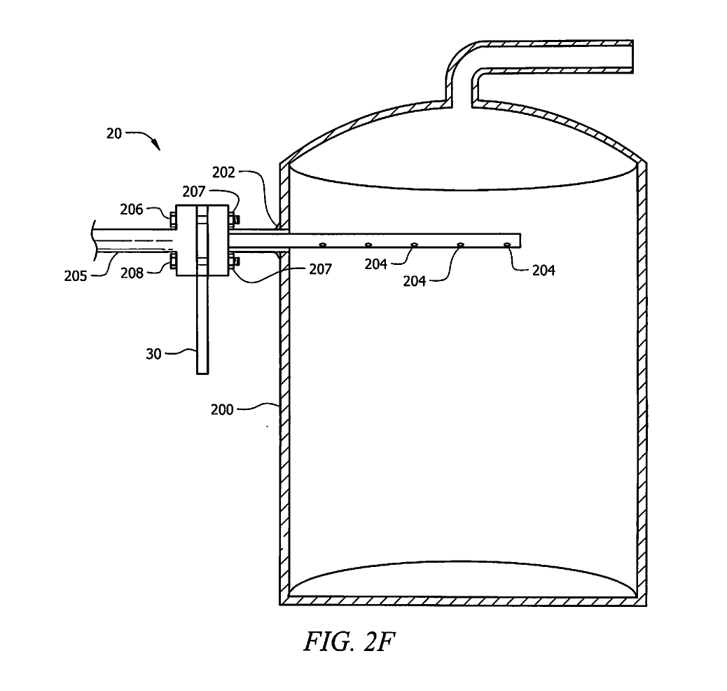

FIG. 1 shows a method of retrofitting a vaporizer according to embodiments of the disclosure. FIGS. 2A to 2F show steps in retrofitting vaporizer systems according to embodiments of the disclosure. FIG. 2A shows a vessel fitted with circular lances. Also shown in FIG. 2A is manifold 205, which is configured to be attached to a circular lance. For vaporizer designs that include a lance cluster, such as lance cluster 701, the manifold is configured to be attached to coupling 702 that transitions to a lance header having a square cross sectional shape. According to FIG. 1, method 10 begins with step 101, which involves the removal of a circular lance, such as lance 402 (FIG. 2A), or the removal of a lance cluster and transition coupling, such as lance cluster 701 and coupling 702, from a vessel being retrofitted. Step 102 involves removing the screw thread mechanism (device 602 and pipe 603) from vaporizer system 20, as shown in FIG. 2B.

For vaporizer designs that include a lance cluster, such as lance cluster 701, coupling 702 is removed from the vaporizer system. Step 102 may also include adding flange 201 (FIG. 2C) using a fastening mechanism different from the screw thread mechanism. For example, other fastening mechanisms include bolted flanges, press fit mechanisms, welding the like and combinations thereof. In the embodiment shown in FIG. 2C flange 201 is attached to vessel 200 by weld 202. Flange 201 includes bolt holes 201a for receiving connecting bolts. Though manifold 205, is configured to be attached to a circular lance, the embodiments disclosed herein can retrofit vessel 200 with lances that are not circular in shape without making modifications to manifold 205. Further, for vaporizer designs that include a lance cluster, such as lance cluster 701, embodiments of the disclosure can retrofit a vessel with lances such as quadrilateral lances without headers and without a coupling that transitions from one cross sectional shape to another, such as coupling 702.

At step 103, plated lance 21 (FIG. 2D) is inserted into vessel 200 as shown in FIG. 2E. FIG. 2D shows that plated lance 21 includes lance 203 and retrofitting plate 30. In embodiments, lance 203 is a tube having a quadrilateral cross sectional shape and a lumen 210. Lance 203 also includes injection holes 204. Lance 203 may be made from materials such as metal, plastics, composite material, the like and combinations thereof. Lance 203 is connected to retrofitting plate 30 in a manner such that fluids will not leak from this connection. In embodiments, lance 203 is welded to retrofitting plate 30. However, other fastening means may be used. Indeed, in embodiments, plated lance 21 may be molded at the time of manufacture so that lance 203 and retrofitting plate 30 form one unit.

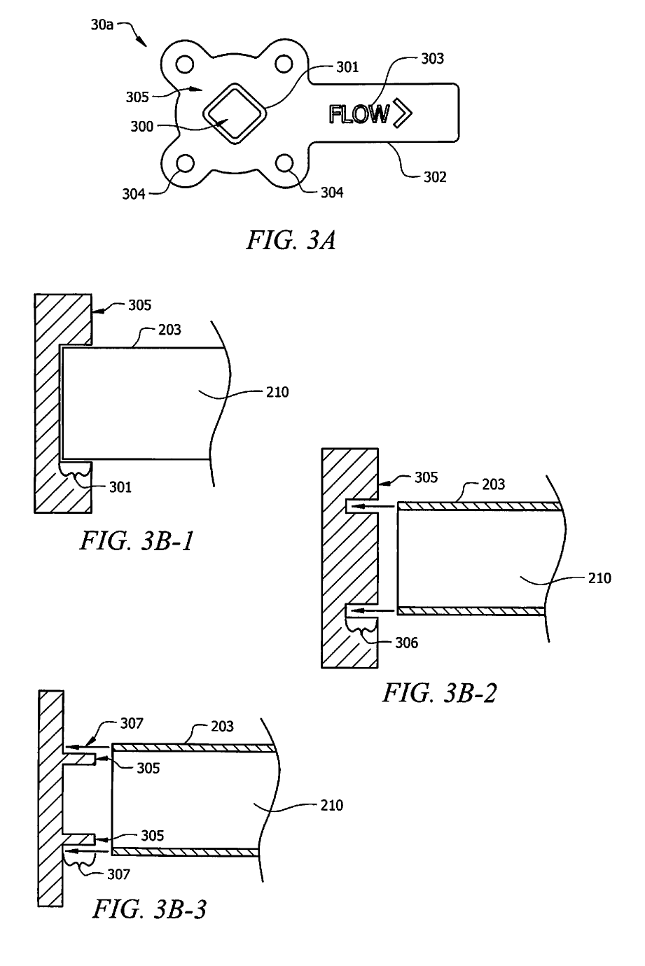

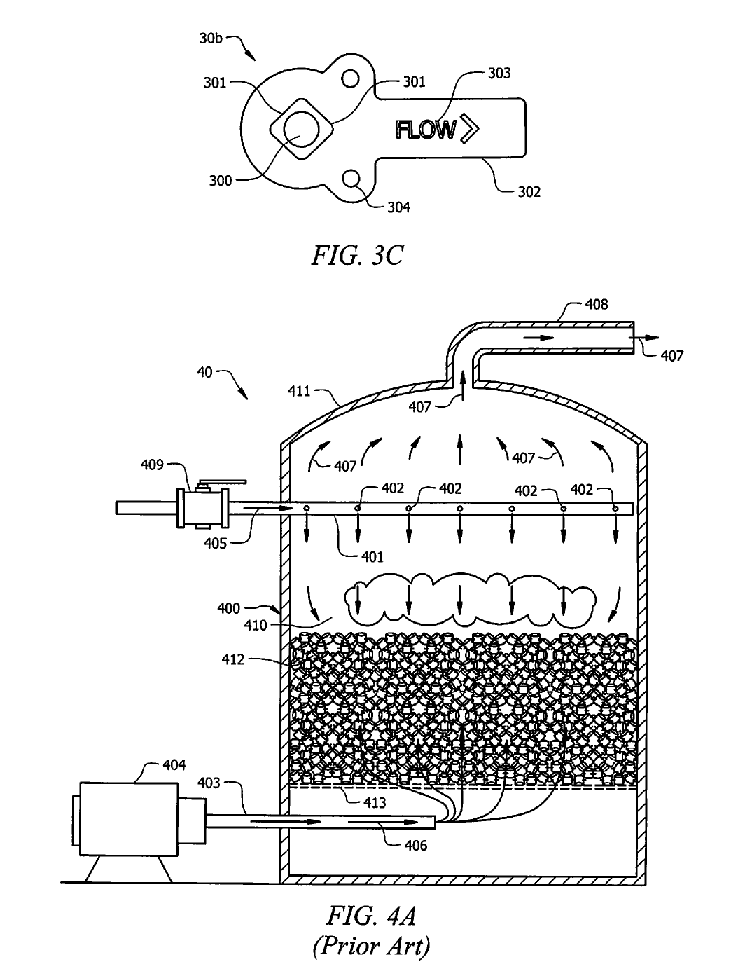

Embodiments of retrofitting plate 30 are shown as retrofitting plates 30A to 30C in FIGS. 3A to 3C, respectively. Considering FIG. 3A, retrofitting plate 30A includes orifice 300 and recess 301 around orifice 300. Recess 301 is shaped to receive lance 203. That is, recess 301 is shaped to receive the quadrilateral cross sectional shape of lance 203 and provide a tight fit for connection so that fluids do not leak between retrofitting plate 30 and lance 203. In embodiments, lance 203 is connected to retrofitting plate 30 by welds. However, other fastening means may be employed. Depending on the application of vaporizer 20, it may be desirable to construct plated lance 21 so that the connection between lance 203 and retrofitting plate 30 is very resistant to leaking. In this regard, there are different designs for achieving this objective according to embodiments of the disclosure. This is especially relevant in the scenario where lance 203 and plate 30 are manufactured separately and later joined together by one of the above mentioned fastening mechanisms. According to embodiments of the disclosure, one way of achieving this is to provide a recess 301 in retrofitting plate 30 into which lance 203 fits. Fitting lance 203 into recess 301 helps to create a sturdy and leak free connection. Different configurations of the recess, such as those shown in FIGS. 3B-1 to 3B-3, may be used according to embodiments of the disclosure.

In FIG. 3B-1, recess 301 recesses from surface 305 and has a quadrilateral shape so as to receive lances 203, which also have a quadrilateral cross sectional cross shape. Here, there is no plate material within the inner perimeter of the lance. FIG. 3B-2 shows a recess design that is similar to recess 301 of FIG. 3B-1 except that there is a raised portion, surface 305, on the inner perimeter of recess 306. FIG. 3B-3 shows an inner raised surface 305 and recess 307 that extends outside the perimeter of lance 203. All of FIGS. 3B-1 to 3B-3 show designs that are more sturdy and less prone to leaks as compared to a design in which recesses are not present.

Returning to FIG. 3A, orifice 300 allows fluid to flow through the orifice into lumen 210 of lance 203. It should be noted that though orifice 300 is shown with the same shape as recess 301, in embodiments, orifice 300 may have any shape such as circular, oblong, triangular and the like. For example, FIG. 3C shows retrofitting plate 30-b with quadrilateral recess 301 and circular orifice 300.

In the current art, lances are usually constructed with injection holes that point in a particular direction. That direction is usually the most favorable in facilitating the mixing of the fluids within the vessel. For example, in the embodiment shown in FIG. 2A, injection holes 402 inject fluid downward only for the most ideal mixing. Notably, holes 402 are in a straight line on the bottom surface of lance 401. With this design, it is commonplace for a mechanic or other installer of lance 401, during installation or replacement, to position lance 401 in the vessel such that holes 402 are pointing in the wrong direction, unknown to anyone.

In recognizing this deficiency in the current design of lances, embodiments of the disclosure provides a reliable way of ensuring that the installer has installed the lances properly and that others can check this after installation without taking the vessel out of service. In this regard, FIG. 3A shows that retrofitting plate 30A includes extension 302, which serves to indicate the direction of flow of fluid from lance 203 into vessel 200. For example, extension 302 may be connected to lance 203 at the corresponding corner at which holes 204 are located on lance 203 and through which fluid flows into vessel 200. Additionally, inscription 303 may be included on extension 302 that more directly indicates the direction of flow of fluid from lance 203 into vessel 200. Because plate 30 is securely connected to lance 203 (e.g. by welding), there is provided, by extension 302, a reliable method of making all concerned aware of the direction of flow of fluid from lance 203 when lance 203 is inserted into vessel 200. Retrofitting plate 30A may also include one or more bolt holes for receiving one or more connecting bolts. In the embodiment shown in FIG. 3A, retrofitting plate 30A includes four bolt holes 304. FIG. 3C shows retrofitting plate 30B, which has similar features as retrofitting plate 30A, except that retrofitting plate 30B includes two bolt holes 304 instead of four and, as mentioned above, its orifice has a different shape.

Returning to method 10 of FIG. 1, once plated lance 21 is inserted into vessel 200, at step 104, manifold 205 is attached to retrofitting plate 30 so that manifold 205 and lance 203 are in fluid communication. As shown in FIG. 2E, manifold 205, retrofitting plate 30 and flange 201 are connected by placing bolts 206 through bolt holes 208, 304 and 201a and securing bolts 206 by nuts 207. Notably, the injection holes are pointed in the correct direction (in this case, downward), as is extension 302.

The benefits of retrofitting vaporizer system 20 as described herein are many fold. First, vaporizer system no longer has a screw thread mechanism that might cause fluid leaks. Second, as compared to lance clusters, it is much easier for individual lances to be removed and cleaned from its vessel. Third, there is no need for a tubular transition connector for transitioning from a quadrilateral shaped lance to a circular manifold. Fourth, there is a permanent and reliable method of identifying the direction of flow through lances.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of retrofitting a vaporizer having a vessel with one or more lances disposed within said vessel, said method comprising:
replacing, in said vaporizer, a first lance having a first cross sectional shape with a second lance having a second cross sectional shape, wherein said first and second cross sectional shapes are different and wherein a retrofitting plate is connected to a first end of said second lance, said retrofitting plate comprising:
an orifice configured so that fluid flows through said orifice into a lumen of said second lance.

2. The method of claim 1 further comprising:
connecting said second lance to a manifold external to said vessel via said retrofitting plate, wherein said first lance was connected to said manifold prior to said replacing.

3. The method of claim 2 wherein said replacing comprises:
disconnecting said first lance from said manifold;
removing said first lance from said vaporizer; and
inserting a second end of said second lance into said vaporizer.

4. The method of claim 1 wherein said retrofitting plate has been connected to said second lance by inserting said second lance into a recess in said retrofitting plate and welding said second lance to said retrofitting plate.

5. The method of claim 1 wherein said retrofitting plate and said second lance has been molded as one unit at the time of manufacture.

6. The method of claim 1 wherein said first cross sectional shape is a circle and said second cross sectional shape is a quadrilateral.

7. The method of claim 1 wherein said connecting said lances to said manifold comprises any of the methods selected from the list consisting of: bolting, welding, press fitting and combinations thereof.

8. The method of claim 1 wherein said retrofitting plate further comprises an extension adapted to provide an indication of a direction of flow of a fluid from said second lance.

9. A method of retrofitting a vaporizer having a vessel with a lance cluster attached to a main manifold external to said vessel by a tubular transition connector, said method comprising:
removing said lance cluster from said vessel;
removing said tubular transition connector from said main manifold;
inserting one or more plated lances into said vessel; each of said one or more plated lances comprising:
a lance; and
a plate connected to a first end of said lance, said plate comprising an orifice configured so that fluid flows through said orifice into a lumen of said lance; and
connecting said plate of said one or more plated lances to one or more manifolds extending from said main manifold.

10. The method of claim 9 wherein said plated lances comprise a quadrilateral cross sectional shape.

11. The method of claim 9 wherein said connecting comprises any of the methods selected from the list consisting of: bolting, welding, press fitting and combinations thereof.

12. The method of claim 9 wherein said plate further comprises an extension adapted to provide an indication of a direction of flow of a fluid from said lance.

13. A retrofitting plate for connecting a manifold to a lance having a quadrilateral cross sectional shape, said lance configured to be used in a vessel of a vaporizer, said plate comprising:
an orifice configured so that fluid flows through said orifice into a lumen of said lance;
a recess around said orifice, said recess adapted to receive said lance having the quadrilateral cross sectional shape such that a perimeter of said recess has said quadrilateral cross sectional shape.

14. The retrofitting plate of claim 13 further comprising:
at least one bolt hole.

15. The retrofitting plate of claim 13 further comprising:
an extension that indicates a direction of flow of a fluid from said lance into said vessel when said lance is inserted into said vessel.

16. The retrofitting plate of claim 15 wherein said extension comprises an inscription indicating said direction of flow.

17. The retrofitting plate of claim 13 wherein said recess is configured such that there is no plate material within the inner perimeter of said lance when said plate is connected to said lance.

18. The retrofitting plate of claim 13 wherein said recess is configured such that there is plate material within the inner perimeter of said lance when said plate is connected to said lance.

19. The retrofitting plate of claim 13 wherein said recess is configured such that there is plate material within the inner perimeter of said lance and there is plate material along the outer perimeter of said lance when said plate is connected to said lance.

20. A plated lance for retrofitting a vaporizer, said plated lance comprising:
a lance having a quadrilateral cross sectional shape; and
a plate connected to a first end of said lance, said plate comprising an orifice configured so that fluid flows through said orifice into a lumen of said lance.

21. The plated lance of claim 20 wherein said plate is welded to said lance.

22. The plated lance of claim 20 wherein said plate and said lance have been molded as one unit at the time of manufacture.

23. The plated lance of claim 20 wherein said plate further comprises at least one bolt hole.

24. The plated lance of claim 20 wherein said plate comprises an extension adapted to provide an indication of a direction of flow of a fluid from said lance.

25. The plated lance of claim 24 wherein said extension comprises an inscription showing said direction of flow.

26. The plated lance of claim 20 wherein said orifice comprises said quadrilateral cross sectional shape.
